(19) United States
(12) Patent Application Publication
(10) Pub. No.: US 2001/0046365 A1
(43) Pub. Date: Nov. 29, 2001

(54) Light unit with a light guiding element

(76) Inventors: Markus Bohle, Dornbirn (AT); Beatrix Frois, Innsbruck (AT)

Correspondence Address: FITZPATRICK CELLA HARPER & SCINTO, 30 ROCKEFELLER PLAZA, NEW YORK, NY, 10112, US

(21) Appl. No.: 09/789,643

(22) Filed: Feb. 22, 2001

Related U.S. Application Data
(63) Continuation of application No. PCT/EP99/06084, filed on Aug. 19, 1999.

(30) Foreign Application Priority Data
Aug. 24, 1998 (DE) 198 38 388.6
Nov. 23, 1998 (DE) 198 53 956.8
Mar. 3, 1999 (DE) 299 03 847.5

(51) Int. Cl. G02B 6/10; G02B 6/34

(52) U.S. Cl. 385/146; 385/36

(57) ABSTRACT

A light (1) comprises a light source (4) and a wedge-shaped light guiding element (3) having two wedge surfaces (11, 13) and a light entry face (10) extending between the wedge surfaces where they are farthest apart. Light from the source (4) enters light guiding element via the face (10) and is reflected by one wedge surface (13) against the other wedge surface (11) where it exits from the light guiding element (3). To improve radiation characteristics, the other wedge surface (11), which is an exit surface, is profiled with adjacent elevations and indentations extending crosswise to the direction of the wedge. A transparent diffuser (20) is positioned at a distance in front of the exit surface (11). The side of the diffuser (20) facing away from the light exit surface is profiled with adjacent elevations and indentations. The distance between the diffuser (20) and the light guiding element (3) prevents light from entering the diffuser at any angle and thus increases the effectiveness of the profiling.

The invention relates to a light unit with a light-guiding element, which in particular is wedge-shaped, according to claims 1 or 3.

Such light units are used for lighting interior spaces, in particular in such cases in which the heat-generating light source should, as far as possible, not be arranged at the site of the lighting itself.

In the case of such light units, light from a light source is coupled laterally into a light-guiding element by way of a light-entry face. The light, which is substantially propagated parallel to the side faces of the light-guiding element, is reflected totally at the side faces of the light-guiding element on account of the selected refractive index of the material, as known from light-guide technology. In order to achieve illumination of the space, the light is decoupled out of the light-guiding element in a suitable manner at one of the side faces.

An optical arrangement for collecting and diffusing light is described in the printed specification DE-OS 29 42 655. This arrangement is used for the background-lighting of visual displays and accordingly is formed in such a way that light-emission that is as uniform as possible is effected in all directions. For this purpose, the light-guiding element has a diffusing face that is permeable to light and also a side face that lies opposite the diffusing face and reflects inwards. For the purpose of decoupling the light out of the light-guiding element, the reflective side face has a series of steps which are connected together by means of sections that are arranged at an angle. If light strikes these sections which are arranged at an angle, it is deflected in such a way that it can leave the light-guiding element by way of the diffusing face.

This arrangement though is not suitable for lighting a room since on account of the roughened diffusing face the light is arbitrarily refracted in different directions, in which case it is possible that glare or dazzlement effects will occur in certain directions. It is precisely in the case of light units for room-lighting though that it is often desirable that the light leave the light-guiding elements just within one comparatively narrowly predetermined angular range.

A further lighting arrangement for background-lighting is described in the printed specification WO 95/12782. The device described therein is used in the first place for the background-lighting of flat screens of electronic displays, for example in the case of LCD-screens. It has a light source and a substantially plate-like light-guiding element with a light-entry face and also a microprism arrangement that is arranged on a side face of the light-guiding element. The individual microprisms of this lighting arrangement have a light-entry face which is optically coupled to the side face of the light-guiding element, a light-exit face which is arranged parallel to said light-entry face and at least one side face that is between the light-entry face and the light-exit face and which is inclined in such a way that the light that impinges upon this side face of the microprism is reflected so that it leaves the light-exit face of the microprism substantially perpendicularly in relation to the side face of the light-guiding element or the light-exit face of the microprism. The materials of the light-guiding element and that of the microprisms preferably have the same or a similar refractive index so that the light from the light-guiding element can be coupled into the microprisms without any difficulty. In this connection, it is also possible for the microprisms to have an elongated form and even extend over the entire length of the light-guiding element.

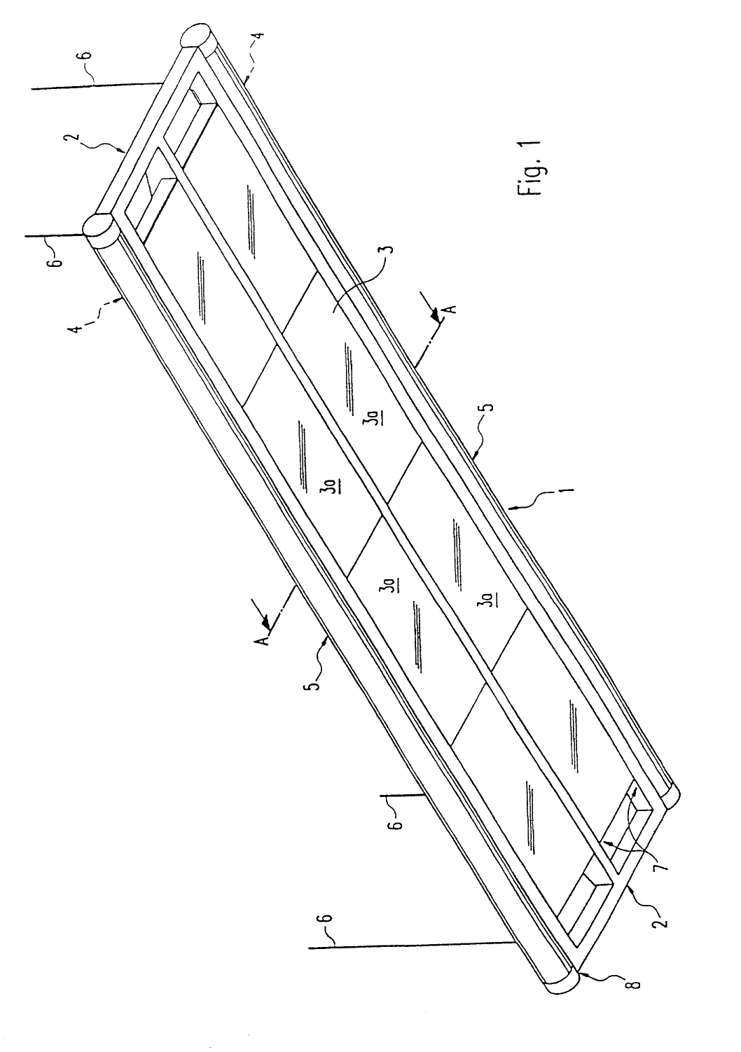

In a further development of this lighting arrangement in WO 96/21122 belonging to the same applicant a lighting arrangement is described in which provided between the side face of the light-guiding element and the microprism arrangement there is a layer that consists of a material that has a lower refractive index than that of the light-guiding element. This layer prevents light with a large angle of incidence in relation to the perpendicular of the side face of the light-guiding element from being able to enter the microprisms. In the case of one of the embodiments (FIG. 1C) that is disclosed in WO 96/21122, the light-guiding element is formed in a wedge-shaped manner in order, as the distance from the light source becomes greater, to generate smaller angles of incidence of the light in relation to the perpendicular of the side face of the light-guiding element, at which angles the light is no longer totally reflected at the side face of the light-guiding element.

The main object of the prisms in the two arrangements mentioned above consists in decoupling the light out of the light-guiding element. Whilst inter alia they also affect the emission into the environment, this influence is greatly reduced by the fact that the light can enter the prisms at any angle. Thus even these lighting arrangements are only conditionally suitable for room-lighting purposes.

Basing considerations on the prior art that has been mentioned it is therefore an object of the present invention to specify a light unit which in a simple manner allows the light that is transported in the light-guiding element to be decoupled within an angular range that is suitable for lighting purposes.

According to a first aspect of the present invention, this object is achieved by means of a light unit that has the features of claim 1.

The light-guiding element, which is used in the light unit in accordance with the invention, is substantially wedge-shaped, wherein the end face of the light-guiding element that is located at the point at which the two wedge faces are furthest apart is the light-entry face for the light that is emitted from the light source, the first wedge face forms an acute angle, that is, an angle of less than 90°, with the light-entry face in such a way that it reflects the light that is radiated into the light-entry face towards the second wedge face, and the second wedge face is the light-exit face of the light-guiding element. As a result of the wedge shape of the light-guiding element, on the one hand, uniform emission of light is achieved over the entire breadth of the light-guiding element and, on the other hand, emission of light out of the light-guiding element within an angular range that is suitable for lighting purposes is guaranteed without any dazzlement effect for the observer. In addition, the light-exit face is profiled crosswise in relation to the direction of the wedge with adjacent elevations and indentations so that the radiation characteristics of the light-guiding element are further improved.

In addition to the profiling of the light-exit face of the light-guiding element, it is advantageous to arrange at a distance in front of the light-exit face a transparent light-diffuser, the side of which that faces away from the light-exit face is profiled with adjacent elevations and indentations, with the profiling of the light-diffuser being orientated substantially crosswise in relation to the profiling of the light-exit face. The possibility of the contours of the profiling becoming visible at certain viewing angles can be eliminated by means of this light-diffuser.

According to a second aspect of the present invention, the object which has been mentioned above is achieved by means of a light unit that has the features of claim 3. The light-guiding element, which is used in the light unit, is also substantially wedge-shaped, wherein the end face of the light-guiding element that is located at the point at which the two wedge faces are furthest apart is the light-entry face for the light that is emitted by the light source, the first wedge face forms an acute angle with the light-entry face in such a way that it reflects the light that is radiated into the light-entry face towards the second wedge face, and the second wedge face is the light-exit face of the light-guiding element. In contrast with the embodiment in accordance with claim 1, the light-exit face of the light-guiding element is not profiled, but arranged in front of the light-exit face of the light-guiding element at a distance therefrom there is a first transparent light-diffuser, the side of which that faces away from the light-exit face is profiled with adjacent elevations and indentations. As a result of the spacing between the light-diffuser and the light-guiding element a situation is avoided where light enters the light-diffuser at any angle, whereby the effectiveness of the profiling is clearly increased. Within the scope of the invention though it is also possible to arrange the light-diffuser in front of the light-exit face of the light-guiding element without any interspacing, that is, at a distance therefrom that is equal to zero.

Analogously to the first embodiment, in addition to the first light-diffuser arranged in front of the light-exit face of the light-guiding element there is a second transparent light-diffuser, the side of which that faces away from the light-exit face is profiled with adjacent elevations and indentations, with the profiling of the second light-diffuser being orientated substantially crosswise in relation to the profiling of the first light-diffuser.

The first wedge face of the light-guiding element preferably has flank sections which are inclined inwards in relation to the plane of the light-exit face, with their angle of inclination in relation to the plane of the light-exit face preferably amounting to approximately 30° to 50°. Moreover, according to a further development of the invention these flank sections, in particular at the end of the light-guiding element that faces away from the light source, are formed so as to be curved concavely or convexly so that the angular range of the light that emerges from the light-guiding element over the entire breadth of the light-guiding element lies as uniformly as possible within the suitable range of approximately 60° to 90° in relation to the plane of the light-exit face.

Furthermore, advantageously provided between these flank sections of the first wedge face of the light-guiding element there are sections which are aligned either so as to be substantially parallel to the plane of the light-exit face or which are inclined outwards in relation to the plane of the light-exit face, with, in the latter case, their angle of inclination in relation to the plane of the light-exit face being smaller than approximately 30°.

Furthermore, for reasons of manufacturing techniques it is advantageous to produce the light-guiding element from a plurality of component parts. In this way, in particular if the light-guiding element is produced by means of plastics-injection moulding, material defects on account of possibly uneven cooling of the injection-moulding plastics compound are avoided.

The light unit in accordance with the invention can, for example, have one light source which is arranged between two light-guiding elements or else one light-guiding element which is arranged between two light sources.

In a further development of the invention, the light sources of the lighting arrangement are surrounded by a reflector arrangement that guarantees that all of the light emitted by the light sources is coupled into the light-guiding elements so that the highest possible level of luminous efficiency can be attained.

Further advantageous configurations and further developments of the present invention constitute subject-matter of further subclaims.

The invention is explained in greater detail in the following with the aid of preferred exemplary embodiments and with reference to the enclosed drawing, in which:

FIG. 1 shows a first exemplary embodiment of a light unit in accordance with the present invention in a perspective bottom view;

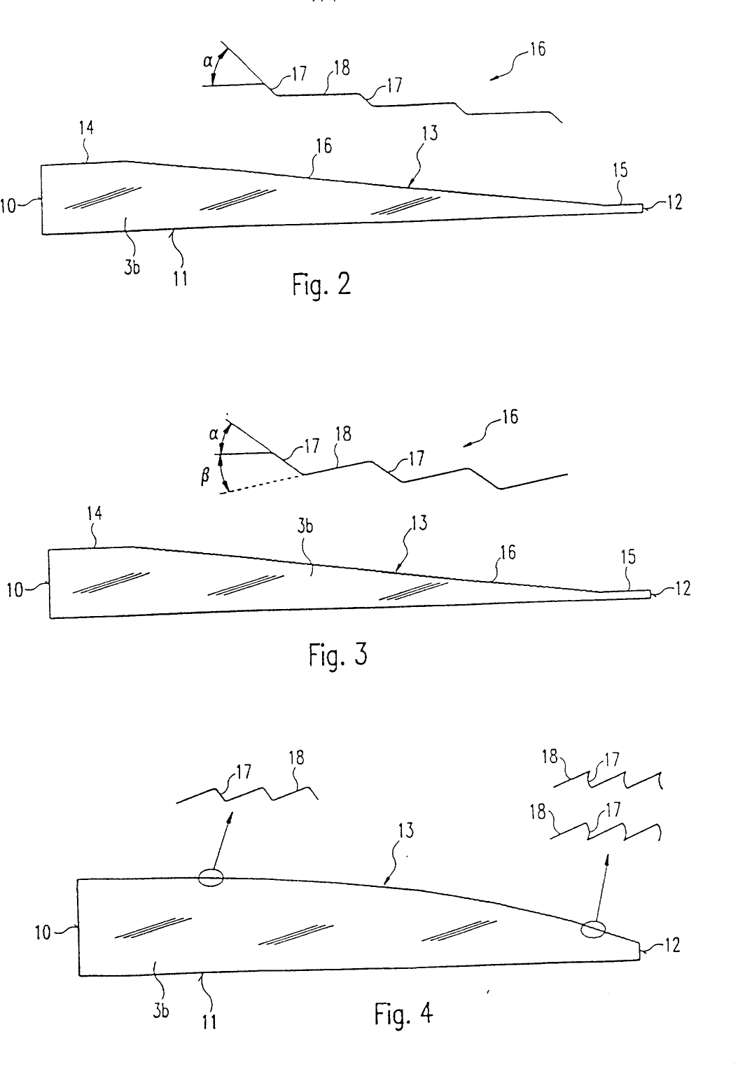

FIG. 2 shows a first exemplary embodiment of a light-guiding element, which is used in the light unit, in accordance with the present invention in a diagrammatic representation in the section A-A in accordance with FIG. 1;

FIG. 3 shows a second exemplary embodiment of a light-guiding element, which is used in the light unit, in accordance with the present invention in a diagrammatic representation in the section A-A in accordance with FIG. 1;

FIG. 4 shows a third exemplary embodiment of a light-guiding element, which is used in the light unit, in accordance with the present invention in a diagrammatic representation in the section A-A in accordance with FIG. 1;

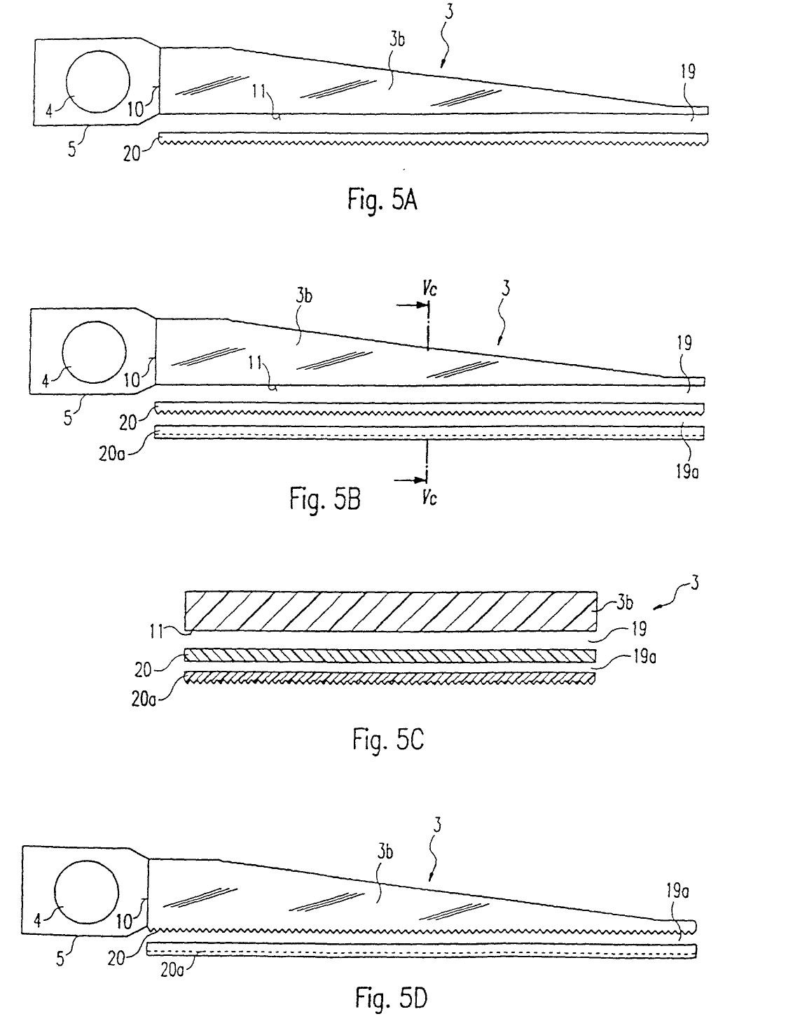

FIG. 5A shows a second exemplary embodiment of a light unit in accordance with the present invention in a diagrammatic representation in the section A-A in accordance with FIG. 1;

FIG. 5B shows a third exemplary embodiment of a light unit in accordance with the present invention in a diagrammatic representation in the section A-A in accordance with FIG. 1;

FIG. 5C shows the light unit of FIG. 5B in the section Vc-Vc in accordance with FIG. 5b;

FIG. 5D shows a fourth exemplary embodiment of a light unit in accordance with the present invention in a diagrammatic representation in the section A-A in accordance with FIG. 1;

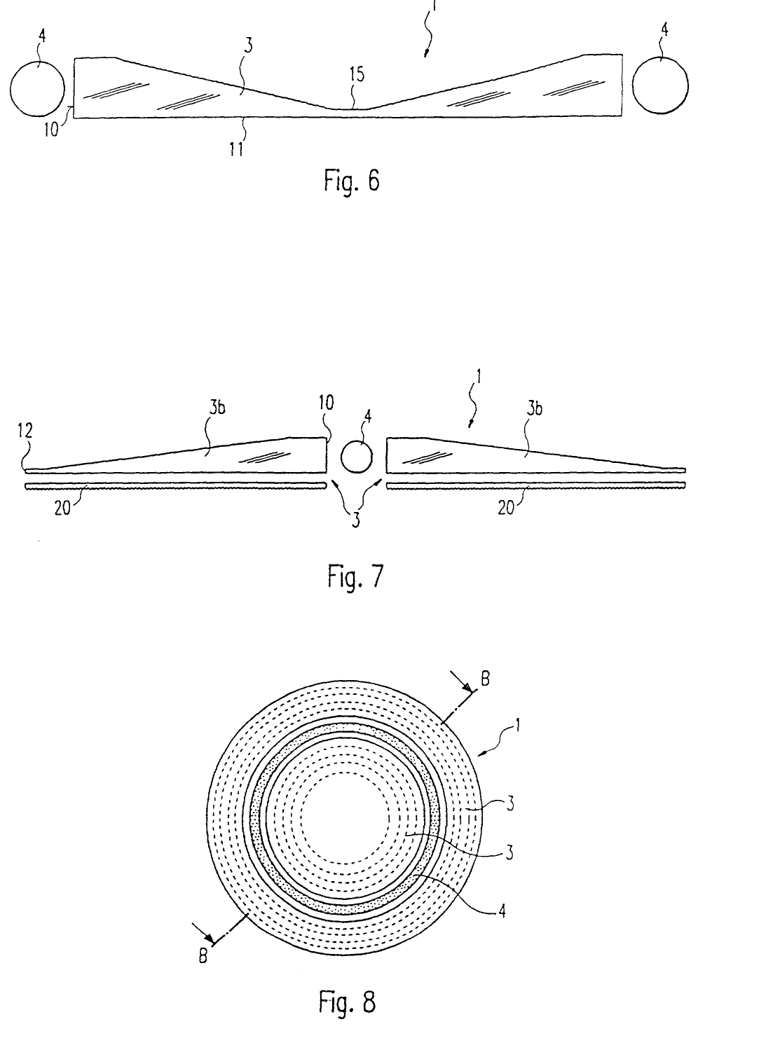

FIG. 6 shows a fifth exemplary embodiment of a light unit in accordance with the present invention in a diagrammatic representation in the section A-A in accordance with FIG. 1;

FIG. 7 shows a sixth exemplary embodiment of a light unit in accordance with the present invention in a diagrammatic representation in the section A-A in accordance with FIG. 1;

FIG. 8 shows a seventh exemplary embodiment of a light unit in accordance with the present invention in a diagrammatic representation in a top view; and

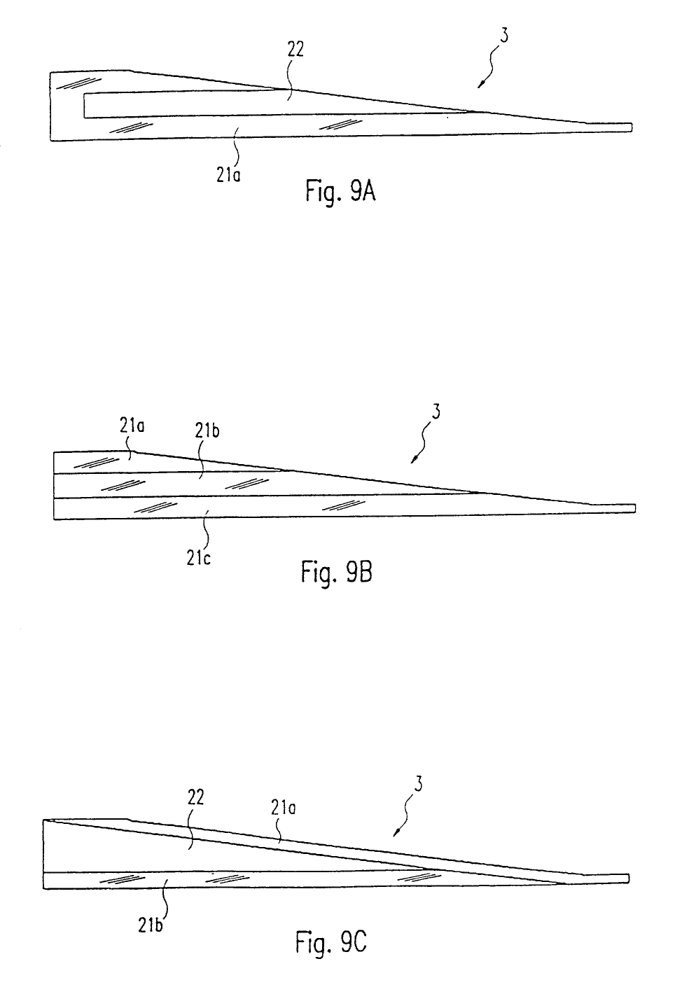

FIGS. 9A to C show further exemplary embodiments of a light-guiding element, which is used in the light unit, in accordance with the present invention in a diagrammatic representation in the section A-A in accordance with FIG. 1.

In FIG. 1 in the first instance a first exemplary embodiment of a light unit in the form of a ceiling light unit is shown in a perspective representation. The light unit shown is used to illuminate a space or room, in which case, within the scope of the present invention, basically interior lighting and also outdoor lighting are to be understood by this. The term room-lighting shall be used in particular to point out the difference with respect to lighting arrangements for background-lighting, as explained in greater detail in the introduction to the description with reference to the prior art.

The light unit 1 has a light-unit carrier 2, two disc-like or plate-like light-guiding elements 3 which are composed of a plurality of similar partial elements 3a, two light sources 4 which are arranged on the respective end faces relative to a light-guiding element 3, and a respective reflector arrangement 5 that is arranged on the narrow side on which the light source 4 is located. In the exemplary embodiment of FIG. 1 an elongated fluorescent tube is used as the light source 4. Furthermore, holding arrangements 6 are provided on the light unit 1 in order to secure the light unit 1 to a carrier which is not shown, such as, for example, the ceiling of a room. Furthermore, holding arrangements 7 for detachably securing the light-guiding elements 3 to the light-unit carrier 2 and holding arrangements 8 for detachably securing the reflector arrangements 5 to the light-unit carrier 2 are indicated in FIG. 1. Operating means, such as electrical connecting portions and, for example, ballasts for the fluorescent tubes 4, are omitted in FIG. 1 for the sake of simplicity.

Three preferred exemplary embodiments of a light-guiding element 3 are described in greater detail in the following with reference to the diagrammatic cross-sectional representations which are shown in FIGS. 2 to 4.

The substantially wedge-shaped light-guiding element 3b consists of a light-guiding body 3b, with the end face 10 that is located at that point at which the two wedge faces 11, 13 are furthest apart being the light-entry face of the light-guiding element for the light that is emitted by the light source 4, through which light-entry face light from the light source 4, which is arranged in the vicinity of this light-entry face 10, can be coupled into the light-guiding body 3b in a manner known per se. Furthermore, the first wedge face 13 forms on average an acute angle, that is, an angle of less than 90°, with the light-entry face 10. As a result of this design, the light that is radiated into the light-entry face 10 is reflected towards the second wedge face 11 that serves as a light-exit face and out of which the light that is transported in the light-guiding body 3b can be decoupled in the manner described further below. For this reason, the first wedge face 13 is also termed the reflective face in the following. All of the light-guiding bodies 3b shown in FIGS. 2 to 4 have a smooth light-exit face 11. As will be explained further below with reference to FIG. 5D, the light-exit face can, however, also be profiled. The end face 12 of the light-guiding body 3b that lies opposite the light-entry face 10 is formed so as to be reflective.

The light-guiding body 3b consists of a transparent material, such as, for example, glass or a plastics material. The refractive index of this material is selected so that in the wave range of the selected light, for example approximately 400 to 700 nm or even approximately 250 to 700 nm, at large angles of incidence in relation to the perpendicular of the boundary surfaces of the light-guiding body 3b, that is more precisely at angles of incidence that are greater than the limit angle, total reflection of the light takes place in the interior of the light-guiding body 3b. Suitable materials have a refractive index of approximately 1.45 to 1.65, preferably approximately 1.50 to 1.60. Thus the light that is coupled into the light-guiding body 3b from a light source 4 through the light-entry face 10 and which propagates substantially parallel to the light-exit face 11 of the light-guiding body 3b, is in the first instance transported in this direction through the light-guiding body 3b without being able to leave it through the light-exit face 11.

Moreover, the light-guiding body 3b has a reflective face 13 which is arranged opposite the light-exit face 11 and the plane of which in the edge regions 14, 15 extends substantially parallel to the light-exit face 11 and in the region 16 between these edge regions 14, 15 extends obliquely in relation to the light-exit face 11. The angle of inclination of the intermediate region 16 in relation to the plane of the light-exit face 11 preferably amounts to approximately 5° to 15°, in particular preferably to approximately 6° to 10°, with the light-guiding body 3b being formed so as to be higher at the light-entry face 10 than at the opposing end face 12. The edge regions 14, 15 of the light-guiding body 3b serve as supporting or holding surfaces for securing the light-guiding element 3 in a lighting arrangement 1.

As can be seen clearly in particular in the enlarged cutout portions of FIGS. 2 and 3, the reflective face 13 in the intermediate region 16 has flank sections 17 which are inclined in relation to the plane of the light-exit face 11 in the direction of propagation of the light in the light-guiding body 3b. The angle of inclination α of the flank sections 17 preferably amounts to 30° to 50°, in particular preferably to 35° to 45°, with the selected angle of inclination α depending upon the refractive index of the material of the light-guiding body 3b and the choice of the light or its wavelength. Moreover, the reflective face 13 is, or at least the flank sections 17 of the intermediate region 16 are, advantageously formed so as to be totally reflective in order to guarantee that no light can emerge through this reflective face 13 out of the light-guiding body 3b. For this, the outside of the reflective face 13 is, for example, coated with a reflective material, preferably mirror-coated.

The sections 18 of the reflective face 16 between these flank sections 17, in the exemplary embodiment of FIG. 2, are formed so as to be parallel to the plane of the light-exit face 11. In the case of the exemplary embodiment of FIG. 3, on the other hand, these sections 18 are also inclined by an angle of inclination β so that in the intermediate region 16 a substantially zigzagging course of the reflective face 13 results. The angle of inclination β of the sections 18 is preferably smaller than approximately 30° and in particular is preferably approximately 10°. The embodiment of the light-guiding body 3b that is currently most preferred in terms of lighting techniques has a reflective face 13 with an intermediate region 16, the flank sections 17 of which are inclined downwards at an angle of inclination α of approximately 40° and the sections 18 of which between the flank sections 17 are inclined upwards at an angle of inclination β of approximately 10° in relation to the plane of the light-exit face 11.

The flank sections 17 that are provided in such a way reflect the light that impinges upon them back into the interior of the light-guiding body 3b. In this connection, even light beams that proceed substantially parallel to the plane of the light-exit face 11 in the light-guiding body 3b and which cannot therefore emerge out of the light-exit face 11, on account of the fact that the limit angle for the total reflection is exceeded, are reflected by the flank sections 17 on account of the angle of inclination α in such a way that they strike the light-exit face 11 at an angle of incidence at which they are able to leave the light-guiding body 3b. The specific choice of the angle of inclination α causes the light to leave the light-exit face 11 of the light-guiding body 3b at least for the most part at an angle that is suitable for general lighting purposes, that is, the light leaves the light-exit face 11 substantially within an angular range of approximately 60° to 90° in relation to the plane of the light-exit face 11 so that crosswise dazzlement of the light of the lighting arrangement 1 is largely suppressed.

In addition, the edges, which are formed between the flank sections 17 and the sections 18 on the reflective face 13 can be rounded off with a suitable radius of curvature. This is advantageous in order to reduce the light-dark contrast between flank sections 17 which are directly irradiated and those which are only indirectly irradiated.

A further exemplary embodiment of a light-guiding body 3b is shown in FIG. 4. The reflective face in this connection, in the crosswise direction of the light-guiding body 3b, has a concave curvature which extends substantially from the light-entry face 10 as far as the end face 12 lying opposite, in which case the light-guiding body 3b, analogously to the two exemplary embodiments described above, can have edge regions 14, 15 which are aligned so as to be parallel to the light-exit face 11. The curvature of the reflective face 13 causes light to emerge in a more uniform manner from the light-guiding body 3b over the whole breadth thereof and thus a more uniform lighting effect is achieved.

If the flank sections 17 and the sections 18 are formed as in one of the two exemplary embodiments described with reference to FIGS. 2 and 3, this can still result in uneven light-distribution when the light unit is viewed at flat angles, since the angular range of the emergence of light out of the light-guiding body 3b is greater in the region that faces the light source 4, that is, flatter angles of emergence also occur, than in the region of the light-guiding body 3b that faces away from the light source 4. For this reason, it is advantageous to vary the shape of the flank sections 17 in the crosswise direction of the light-guiding body 3b.

As shown in the enlarged cut-out portions of FIG. 4, the flank sections 17 and the sections 18 in the region that faces the light-entry face 10 are formed as in the exemplary embodiments of FIGS. 2 and 3. The flank sections 17 are inclined inwards in relation to the plane of the light-exit face 11 in the direction of propagation of the light in the light-guiding body 3b, whilst the sections 18 which lie between these flank sections 17 are inclined outwards. In the region of the light-guiding body 3b that faces away from the light-entry face 10, on the other hand, the flank sections 17 are curved convexly or concavely. The transition from flank sections 17 which are formed in a straight line in cross section to flank sections which are curved is preferably a smooth transition.

It is possible, furthermore, that as a result of suitable choice of the dimensions, the angles of inclination and the edge shapes of the flank sections 17, special effects in terms of lighting techniques, such as, for example, the decomposition of the light into its spectral colours, can be achieved. Such special effects could be of interest in particular in the field of advertising.

Dimensions for such a light-guiding body 3b, which are suitable in practice for various applications, are to be specified, moreover, by way of example. An exemplary embodiment of a light-guiding body 3b that has already been tested has, in the cross section in accordance with FIGS. 2 to 4, an overall width of approximately 120-130 mm, a height of approximately 16 mm at the end face of the light-entry face 10 and a height of approximately 2 mm at the end face 12 lying opposite the light-entry face 10. The width of the flat section 14 of the reflective face 13 at the end face facing the light-entry face 10 amounts to approximately 17-19 mm, with the width of the other flat section 15 amounting to approximately 10 mm. Provided in the intermediate region 16 of the reflective face 13 there are approximately 50 steps formed by flank sections 17, in which case the resultant width of these steps is approximately 2 mm and the resultant height of these steps is approximately 0.25-0.30 mm. These dimensions just give a starting point for possible embodiments, yet are not to be considered to be limiting. The person skilled in the art will easily be able to select the dimensions of the light-guiding body 3b that are most suitable for the respective case of application. The respective length of the light-guiding body 3b is adapted in accordance with the type of light source 4 used. In this connection, both elongated or circular ring-shaped light sources, such as straight or curved fluorescent tubes, and also substantially point light sources, such as bulbs, come into consideration as possible light sources 4.

Various exemplary embodiments of light units which are fitted with one or more light-guiding elements 3 of the kind described above are described in the following with reference to the diagrammatic representations of FIGS. 5A to 8, with it being possible in each case to select optionally any embodiment of the light-guiding element 3.

In FIG. 5A the light from a laterally arranged light source 4 is coupled into the light-guiding element 3 or the light-guiding body 3b through the light-entry face 10. Arranged around the light source there is a reflector arrangement 5, only indicated diagrammatically in FIG. 4, which guarantees that all of the light emitted by the light source 4 is coupled into the light-guiding body 3b so that the highest possible level of luminous efficiency can be achieved.

Additionally arranged in front of the light-exit face 11 of the light-guiding body 3b there is a light-diffuser 20, the surface of which that faces away from the light-exit face 11 is profiled. Such a light-diffuser 20 is used to suppress any dazzlement from the light emerging from the light-guiding body 3b in the longitudinal direction of the light unit 1 or the light-guiding body 3b. This profiling is formed by elongated grooves or indentations with elevations located in between. The elevations have a triangular cross section and preferably extend along the longitudinal axis of the light unit 1. The angle of the vertex of the triangle amounts, for example, to approximately 140°. The elevations can also have a different shape in cross section though and can, for example, have a trapezoidal, prism-shaped or rounded-off shape.

The light-diffuser 20, as shown in FIG. 5A, is preferably set at a distance from the light-exit face 11 of the light-guiding body 3b. As a result of this structural measure, only that light whose glare has already been suppressed crosswise in the desired manner by means of the flank sections 17 of the light-guiding body 3b enters the light-diffuser 20 by way of the air gap 19, and the light-diffuser 20 is decoupled in terms of lighting techniques from the light-guiding body 3b so that the effects of the light-guiding body 3b and the prism structure 20 are not superimposed and are therefore substantially simpler to evaluate. It is, however, likewise possible within the scope of the present invention to provide the light-diffuser 20 without interspacing directly at the light-exit face 11 of the light-guiding element 3.

In practice when one single light-diffuser 20 is used, the contours of the profiling are visible from certain viewing angles. This effect can be eliminated by the additional use of a second light-diffuser 20a, with the profiling thereof being orientated crosswise in relation to that of the first light-diffuser 20, since in this case the light is intermixed more evenly. In the exemplary embodiment shown in FIG. 5B therefore, arranged below the first light-diffuser 20, the indentations and elevations of which are aligned in the crosswise direction in relation to the light unit 1, there is a second light-diffuser 20a, the profiling of which is orientated in the longitudinal direction. The different alignment of the profiled portions of the two light-diffusers 20, 20a, is shown again in FIG. 5C in which the light unit 1 is shown in the longitudinal direction in the section Vc-Vc.

A further air gap 19a is preferably provided between the two light-diffusers 20, 20a for decoupling purposes in terms of lighting techniques. If both light-diffusers 20, 20a were to lie directly together one on top of the other, this would result in disturbing effects at the edges, since no refraction takes place there. Whilst it is also possible to realize direct contact of the two light-diffusers 20, 20a with avoidance of these effects, this would necessitate a higher level of outlay with respect to refraction and a complicated structure of the profiling. It would also be possible though to use layers that have a different refractive index instead of the air gaps 19 and 19a respectively.

An advantageous embodiment using two profiled structures is shown in FIG. 5D. Here the light-exit face 11 itself has a profiled structure and thus replaces one of the two light-diffusers 20, 20a, in this case the first one. The possibility of working the light-diffuser 20 directly into the light-guiding body 3b also exists of course in the case of the embodiment in accordance with FIG. 5A. Furthermore, the sequence of the differently orientated light-diffusers 20, 20a or the profiled structures is interchangeable.

As shown in FIG. 6, it is possible, furthermore, to configure the light-guiding element 3 in such a way that it can be used between two light sources 4. The light-guiding element 3 in this case is composed, so to speak, of two light-guiding elements, as shown in FIGS. 2 to 4, with these being joined at the respective low end faces 12 lying opposite the light-entry face 10. The flat section 15 that is formed in this way in the centre of the light-guiding body 3b is not absolutely necessary, although can, for example, be used in order to achieve special effects, such as a darker central region of the light unit 1.

The two light sources 4 are self-evidently, as in FIGS. 5A to 5C, each surrounded by a reflector arrangement 5 (not shown) to couple all the light emitted by the light sources 4 into the light-guiding body 3b. Moreover, in the case of this exemplary embodiment of the light unit 1 of course the light-exit face 11 of the light-guiding body 3b can also be profiled or at least one light-diffuser 20 or 20a can be provided.

An exemplary embodiment of a light unit 1 having one light source 4 arranged in the centre and two light-guiding elements 3 arranged on the outside is shown next in FIG. 7. The light is coupled from the light source 4 on both sides by way of the respective light-entry faces 10, facing the common light source 4, into the two light-guiding elements 3, with the light source 4 in this case also being provided with a reflector arrangement 5, which is not shown. The end faces 12 of the light-guiding bodies 3b facing away from the light source 4 are each formed so as to be reflective in order to keep the light in the light-guiding elements 3. Both light-guiding elements 3 can be formed in accordance with one of the embodiments of FIGS. 5A to 5D.

A further specific embodiment of a light unit 1 is shown in FIG. 8 in a top view.

An annular light source, such as, for example, a fluorescent tube bent in the form of a circular ring, is used as the light source 4. Arranged both inside and outside this annular light source 4 there is a respective light-guiding element 3 which is substantially circular or circular-ring shaped. In the cross section in accordance with the section B-B of FIG. 8, this light unit 1 is a combination of the light units of FIGS. 6 and 7, in which case the whole light unit of FIG. 6 is to be used instead of the common light source 4 of the light unit shown in FIG. 7. The profiling is formed in this example by concentric indentations and elevations.

As an alternative to the exemplary embodiment of FIG. 8 it is also possible to use a substantially point light source 4 which is surrounded by a, for example, circular ring-shaped or discus-shaped light-guiding element 3. This configuration corresponds, in terms of its cross section, to the section of the light unit of FIG. 7.

It can be seen from the different possible configurations of light units described above that the light-guiding element 3 in accordance with the present invention is suitable for a great variety of embodiments of light units, in which case the person skilled in the art will easily find still further possibilities which are not expressly described in this application. It would, for example, be possible to use a hollowly cylindrical light-guiding element, in which case the light is then coupled into the light-guiding body by way of an annular light source.

Finally, a further aspect of the configuration of the light-guiding element 3 in accordance with the invention shall be explained with reference to FIGS. 9A to C.

In particular for reasons of manufacturing techniques it is advantageous to construct the light-guiding element 3 in several parts. Since, in particular when manufacturing products by means of plastics injection-moulding, uniform thickness of the product is to be striven after for uniform cooling of the plastics injection-moulding compound in order to avoid tensions or even material defects in the products, it is preferably possible to produce the light-guiding bodies 3b in accordance with the present invention as multi-part basic structures.

In FIG. 9B, for example, the light-guiding body 3b is constructed of three layers 21a, 21b and 21c which are arranged one on top of the other. The three layers 2la-c are fixedly connected together by means of a suitable transparent adhesive. By way of contrast, the light-guiding body 3b according to FIG. 9A is formed from a substantially U-shaped profiled element 21a and the hollow space 22 thus formed is filled up with a medium, which has a suitable refractive index and a corresponding outer contour, and connected to the profiled portion 21a. It is also possible here to use, instead of the hollow space 22, a correspondingly shaped carrier element made of a suitable transparent material and to injection-mould around it.

The light-guiding body 3b shown in FIG. 9C is formed in a similar manner from a substantially V-shaped profile that is constructed of two portions 21a and 21b. The hollow space 22 thus formed is in turn filled up with a suitable medium.

1. Light unit having the following features:
a) at least one light source (4);
b) a wedge-shaped light-guiding element (3);
b-1) the end face (10) of the light-guiding element (3) that is located at the point at which the two wedge faces (11, 13) are furthest apart is the light-entry face for the light that is emitted by the light source (4);
b-2) the first wedge face (13) forms an acute angle with the light-entry face (10) in such a way that it reflects the light that is radiated into the light-entry face towards the second wedge face (11);
b-3) the second wedge face (11) is the light-exit face of the light-guiding element (3);
c) the light-exit face (11) is profiled (20) crosswise in relation to the direction of the wedge with adjacent elevations and indentations.

2. Light unit according to claim 1, characterised in that arranged at a distance (19) in front of the profiled light-exit face (11) of the light-guiding element (3) there is a transparent light-diffuser (20a), the side of which that faces away from the light-exit face is profiled with adjacent elevations and indentations, with the profiling of the light-diffuser (20a) being orientated substantially crosswise in relation to the profiling (20) of the light-exit face.

3. Light unit having the following features:
a) at least one light source (4);
b) a wedge-shaped light-guiding element (3);
b-1) the end face (10) of the light-guiding element (3) that is located at the point at which the two wedge faces (11, 13) are furthest apart is the light-entry face for the light that is emitted by the light source (4);
b-2) the first wedge face (13) forms an acute angle with the light-entry face (10) in such a way that it reflects the light that is radiated into the light-entry face towards the second wedge face (11);
b-3) the second wedge face (11) is the light-exit face of the light-guiding element (3);
c′) arranged at a distance (19) in front of the light-exit face (11) of the light-guiding element (3) there is a first transparent plate-like light-diffuser (20), the side of which that faces away from the light-exit face is profiled with adjacent elevations and indentations.

4. Light unit according to claim 3, characterised in that in addition to the first light-diffuser (20) arranged in front of the light-exit face (11) there is a second light-diffuser (20a), the side of which that faces away from the light-exit face (11) of the light-guiding element (3) is profiled with adjacent elevations and indentations, with the profiling of the second light-diffuser (20a) being orientated substantially crosswise in relation to the profiling of the first light-diffuser (20).

5. Light unit according to one of the preceding claims, characterised in that the first wedge face (13) of the light-guiding element (3) has flank sections (17) which are inclined (a) inwards in relation to the plane of the light-exit face (11).

6. Light unit according to claim 5, characterised in that the angle of inclination (a) of the flank sections (17) in relation to the plane of the light-exit face (11) amounts to approximately 30° to 50°.

7. Light unit according to claim 5 or 6, characterised in that the flank sections (17) are formed concavely or convexly.

8. Light unit according to one of claims 5 to 7, characterised in that provided between the flank sections (17) of the first wedge face (13) there are sections (18) which are aligned so as to be substantially parallel to the plane of the light-exit face (11) or which are inclined (β) outwards in relation to the plane of the light-exit face (11).

9. Light unit according to claim 8, characterised in that the angle of inclination (β) of the sections (18) in relation to the plane of the light-exit face (11) is smaller than approximately 30°.

10. Light unit according to one of the preceding claims, characterised in that the profiling of the light-exit face (11) and/or the light-diffusers (20, 20a) is formed by substantially elongated or circular grooves with elevations lying in between, with it being possible for the elevations to be formed so as to be triangular, trapezoidal, prism-shaped or rounded off in cross section.

11. Light unit according to one of the preceding claims, characterised in that the light-guiding element (3) is produced out of at least two component parts (2la-c, 22).

12. Light unit according to claim 11, characterised in that the light-guiding element (3) consists of a plurality of layers (21a-c) arranged one on top of the other.

13. Light unit according to claim 11, characterised in that the light-guiding element (3) consists of a profiled portion (21a; 21a-b), the hollow space (22) of which is filled up with a suitable transparent medium.

14. Light unit according to claim 11, characterised in that the light-guiding element (3) consists of a carrier element made of a suitable transparent material around which a suitable plastics material is injection-moulded in order to form the light-guiding element (3).

15. Light unit according to one of claims 1 to 14, characterised in that the light unit (1) has one light source (4) which is arranged between two light-guiding elements (3).

16. Light unit according to one of claims 1 to 14, characterised in that the light unit (1) has one light-guiding element (3) which is arranged between two light sources (4).

17. Light unit according to one of the preceding claims, characterised in that the light source or sources (4) has or have a reflector arrangement (5) or a respective reflector arrangement (5) for coupling all the light that is emitted by the light source or sources into the light-guiding element or elements (3).
